(19) United States
(12) Patent Application Publication
(10) Pub. No.: US 2017/0352505 A1
(43) Pub. Date: Dec. 7, 2017

(54) SWITCH OF BATTERY

(71) Applicant: SHIN CHIN INDUSTRIAL CO., LTD., TAINAN CITY 710 (TW)

(72) Inventor: PAI SHAN WANG, TAINAN CITY 710 (TW)

(21) Appl. No.: 15/171,160

(22) Filed: Jun. 2, 2016

(51) Int. Cl. H01H 19/14

(52) U.S. Cl. CPC H01H 19/14; H01H 2221/01

(57) ABSTRACT

A switch of a battery includes a knob, a cap, a cam and a base. The knob includes a shaft having a lug, and the cap has a slot for passing the knob, and the cam has first and second planes, an inclined plane and a first contact point, and the base has a second contact point, so that when the knob is turned according to a user requirement. The lug of the shaft is slid and moved to the first plane, the inclined plane, or the second plane to achieve the effects of connecting or disconnecting the battery or removing the knob respectively.

### FIELD OF THE INVENTION

The present invention relates to a switch, more particularly to the switch installed to a battery for controlling the power supply of the battery.

### BACKGROUND OF THE INVENTION

Battery is an electric power source provided for starting, illuminating, and operating internal equipments of a transportation mean such as a boat, a motor vehicle, etc. In general, the battery is fixed by using a screw to clamp two elastic arms to connectors of the battery respectively and a nut to fix a terminal of an electric wire to the position of the screw, so that the current of the battery is passed through the battery, the clamp, and the screw and transmitted to the serial wiring terminals to generate kinetic force to start the transportation means. In recent years, technology and science advance, and equipments added to the transportation means causes unnecessary power loss of the battery. Therefore, many manufacturers add a switch to the battery to achieve the anti-leakage and anti-theft effects.

With reference to P.R.C. Publication No. 202977267 for an automobile battery switch, the automobile battery switch comprises a hollow cap, a handle, a shaft coupled to the handle, a lug disposed at an outer end of the shaft, a first through hole formed on the cap, a groove formed at the first through hole and configured to be corresponsive to the lug, a torque transmission member disposed on an outer side of the shaft for limiting the shaft along the circumferential direction, a bump formed on the outer peripheral surface of the torque transmission member, and a blocking member disposed on a side of the groove, wherein the distance between the groove and the blocking member is smaller than the width of the bump. Through the action of turning the handle, the shaft transmits the torque to the switch through the torque transmission member to control the ON or OFF of the circuit. Since the shaft drives the torque transmission member to move coaxially, the lug of the shaft cannot be aligned precisely with the groove or latched into the inner wall of the cap, so as to prevent the handle and the cap from separating from one another.

As disclosed in P.R.C. Patent Publication No. 204130411, a “Battery master switch” includes a casing, a terminal block, a knob, a shaft and wiring board assembly, wherein the terminal block is fixed to the bottom of the casing and has a square slot formed at an upper surface of the terminal block, and the wiring board assembly installed in the square slot, and a sidewall of the square slot limits the rotation of the wiring board assembly along the circumferential direction, and the shaft has a transverse pin and the pin has a roller installed at both ends of the pin separately, and the roller is aligned precisely with a curved surface of the cam at the top of the casing, and the shaft is passed out from the top of the casing in the axial direction and connected to the knob, and a restoring spring is installed to the bottom of the knob, so that the knob drives the shaft to rotate, and the shaft drives the roller to roll on the curve surface of the cam and move downwardly, so that the wiring board is in a close contact with a wiring bolt due to the compression of the spring, so as to improve the flexibility of turning the knob.

As disclosed in E.P.O. Pat. No. 2811500A1, a “Battery cutoff switch for vehicles comprises a casing, a retainer body, an elastic device, a handle and a cam, and the cam has first and second active surfaces, and the handle has a first control member and a second control member configured to be corresponsive to the first and second active surfaces respectively, such that when the handle is turned from an OFF position to an ON position, the second control member and the retainer body at the second active surface are moved from an off contact position to an on contact position, so that the safety function of the contact point of the second control member is assured even in an abnormal condition of turning on the battery.

In view of the aforementioned problems of the prior art, the discloser of this disclosure based on years of experience in the related industry to conduct extensive researches and experiments, and finally provided a feasible solution to overcome the problems of the prior art.

### SUMMARY OF THE INVENTION

In view of the conventional battery having an issue of power loss due to the dark current of equipments of a transportation means, it is a primary objective of the present invention to provide a switch of a battery, wherein the knob is movably passed into the cap, and the knob is slid on the cam to control the ON or OFF of the battery and allow the knob to be removed during the OFF state, so as to achieve the anti-theft effect.

To achieve the aforementioned and other objectives, the present invention provides a switch of a battery, comprising: a knob, having a shaft formed therein, and a lug disposed on both sides of the shaft separately; a cap, having a containing space formed therein, and a slot formed at the exterior of the cap and being in a shape corresponsive to the shaft and the lug of the cap, for passing the knob into the slot; a cam, installed in the containing space of the cap, and having two first planes and two second planes disposed at corresponsive positions of the external periphery of the cam and two inclined planes coupled to the first plane and the second plane, and the plane and the inclined plane being provided for sliding the lug, and the cam having a metal plate installed at the bottom of the cam, and a first elastic member being disposed between the cam and the metal plate, and the metal plate having two first contact points formed thereon; and a base, for containing the cam, and having two second contact points formed at the interior of the base, and a second elastic member being disposed between the base and the cam, and two terminal columns being formed at the bottom of the base.

Wherein, the shaft of the knob may be movably passed into the slot of the cap and disposed on the first and second planes or the inclined plane of the cam, and the cam may be installed between the containing space of the cap and the base, so that when the knob is turned according to a user requirement, the lug of the shaft is slid and moved to the first plane, the inclined plane or the second plane to achieve the effects of connecting or disconnecting the battery and removing the knob, as well as achieving the anti-theft effect by removing the knob.

### BRIEF DESCRIPTION OF THE DRAWINGS

FIG. 1 is a perspective view of the present invention;

FIG. 2 is an exploded view of the present invention;

FIG. 3 is an exploded view of the present invention viewing from another angle;

FIGS. 4-A to 4-B are schematic views of an OFF state of the present invention;

FIG. 5 is a cross-sectional view of an OFF state of the present invention;

FIGS. 6-A to 6-B are a schematic views of an ON state of the present invention;

FIG. 7 is a partial cross-sectional view of an ON state of the present invention;

FIGS. 8-A to 8B are schematic views of an anti-theft state of the present invention;

FIG. 9 is a partial cross-sectional view of an anti-theft state of the present invention;

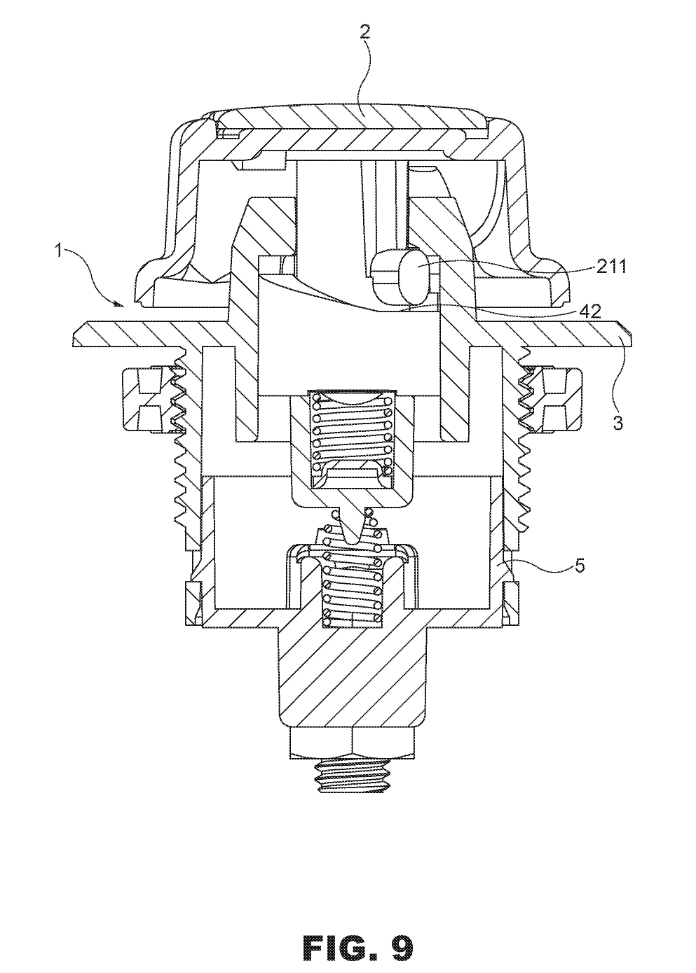

FIG. 10 is a perspective view of another embodiment of the present invention; and

FIGS. 11-A to 11B are schematic views of another embodiment of the present invention.

### DESCRIPTION OF THE PREFERRED EMBODIMENTS

The technical contents of this disclosure will become apparent with the detailed description of preferred embodiments accompanied with the illustration of related drawings as follows. It is intended that the embodiments and figures disclosed herein are to be considered illustrative rather than restrictive.

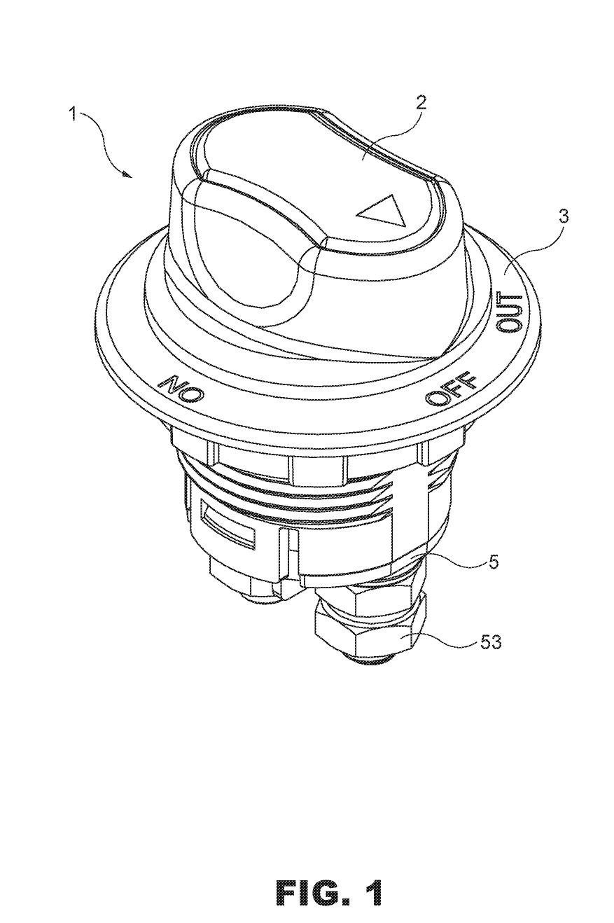

With reference to FIGS. 1 to 3 for a switch of a battery, the switch 1 comprises a knob 2, a cap 3, a cam 4 and a base 5, wherein the knob 2 has a shaft 21 formed therein and a lug 211 disposed on both sides of the shaft 21 separately; the cap 3 has a containing space 31 formed therein and a slot 32 formed on the exterior of the cap 3 and in a shape corresponsive to the shaft 21 and the lug 211 of the knob 2 and provided for passing the shaft 21 and the lug 211 of the knob 2 of the cap 3; the cam 4 is installed in the containing space 31 of the cap 3, and the external periphery of the cam has two first planes 41, two second planes 42 and two inclined planes 43 coupled to the first plane 41 and the second plane 42 and corresponsive to one another, and the first plane 41, the second plane 42 and the inclined plane 43 are provided for sliding and moving the lug 211 of the knob 2, and a metal plate 44 is installed at the bottom of the cam 4, and a first elastic member 45 is installed between the cam 4 and the metal plate 44, and the metal plate 44 has two first contact points 441 formed thereon, wherein the first elastic member 45 of an embodiment of the present invention is a spring; and the base 5 is for containing cam 4, and the base 5 has two second contact points 51 formed therein, and a second elastic member 52 is installed between the base 5 and the cam 4, and two terminal columns 53 are formed at the bottom of the base 5, wherein the second elastic member 52 of an embodiment of the present invention is a spring.

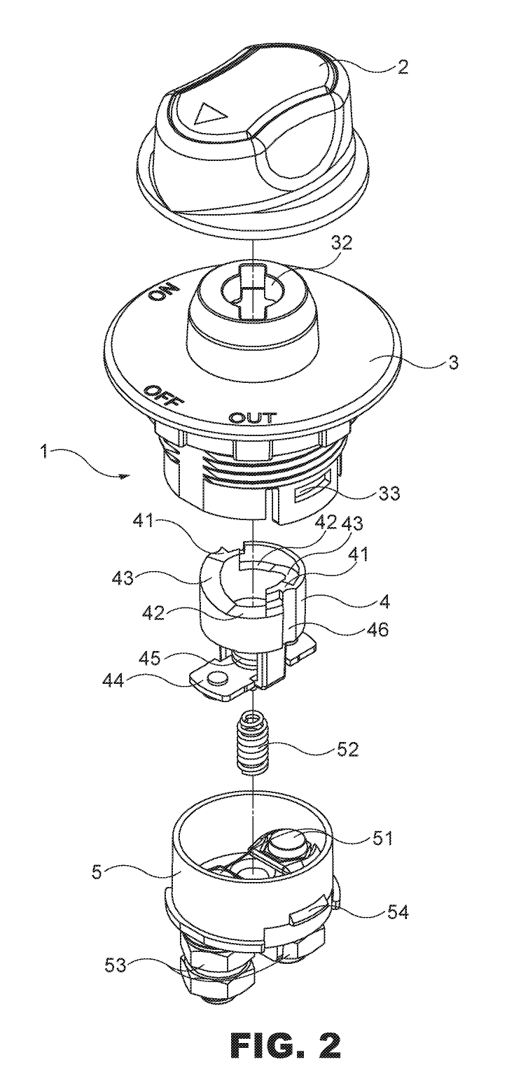

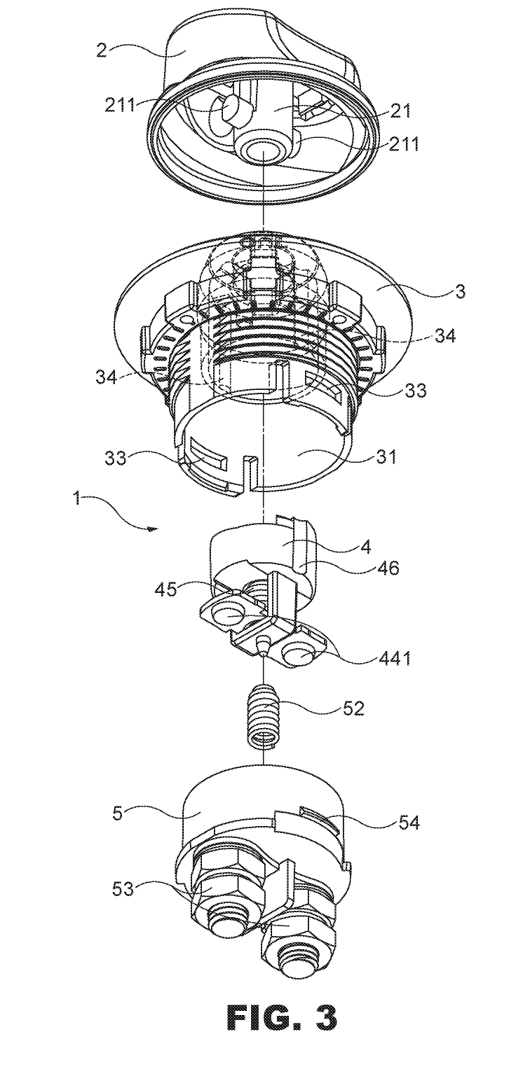

In an embodiment of the present invention as shown in FIGS. 2-3, the cap 3 has two openings 33 formed on the outer side of the cap 3, and at least one arc column 34 is formed in the containing space 31, and the external periphery of the cam 4 has at least one arc groove 46 corresponsive to the arc column 34, and the outer side of the base 5 has two bumps 54 corresponsive to the opening 33 of the cap 3. In assembling, the shaft 21 and the lug 211 of the knob 2 are movably passed into the slot 32 of the cap 3, and the arc groove 46 of the cam 4 and the arc column 34 of the cap 3 are embedded and engaged with each other, so that the cam 4 is disposed in the containing space 31 of the cap 3, and the lug 211 of the knob 2 abuts the position of the first plane 41, the second plane 42 or the inclined plane 43 of the cam 4, and the base 5 is plugged into the containing space 31 of cap 3, and the bump 54 of the base 5 is embedded and fixed into the opening 33 of the cap 3.

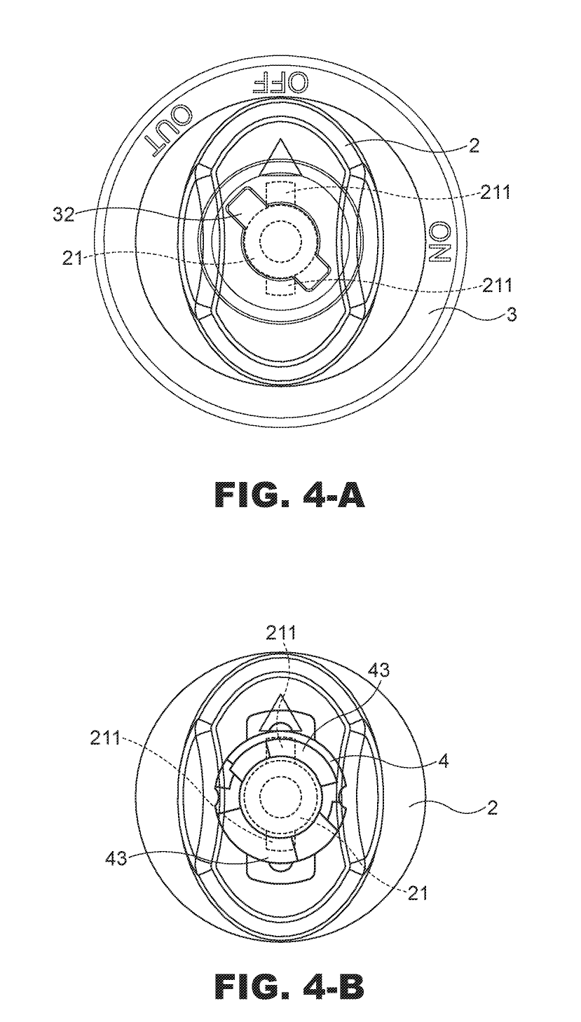

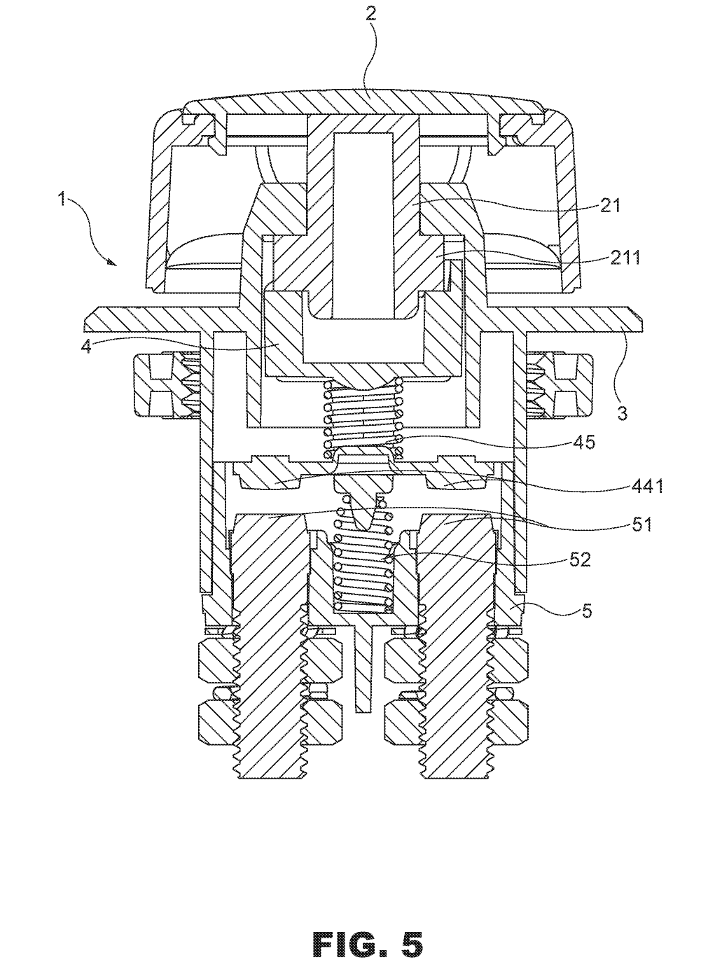

With reference to FIGS. 4-A to 4-B for setting the battery at an OFF state, the knob 2 of the switch 1 is turned to an “OFF” position of the cap 3 as shown in FIG. 5. Now, the shaft 21 and the lug 211 of the knob 2 are not configured to be corresponsive to the position of the slot 32 of the cap 3 and are disposed on the two inclined planes 43 of the cam 4. Due to the elastic restoring force of the first elastic member 45 and the second elastic member 52, a gap is formed between the first contact point 441 of the cam 4 and the second contact point 51 of the base 5 as shown in FIG. 5, so that the switch 1 is situated at an OFF state.

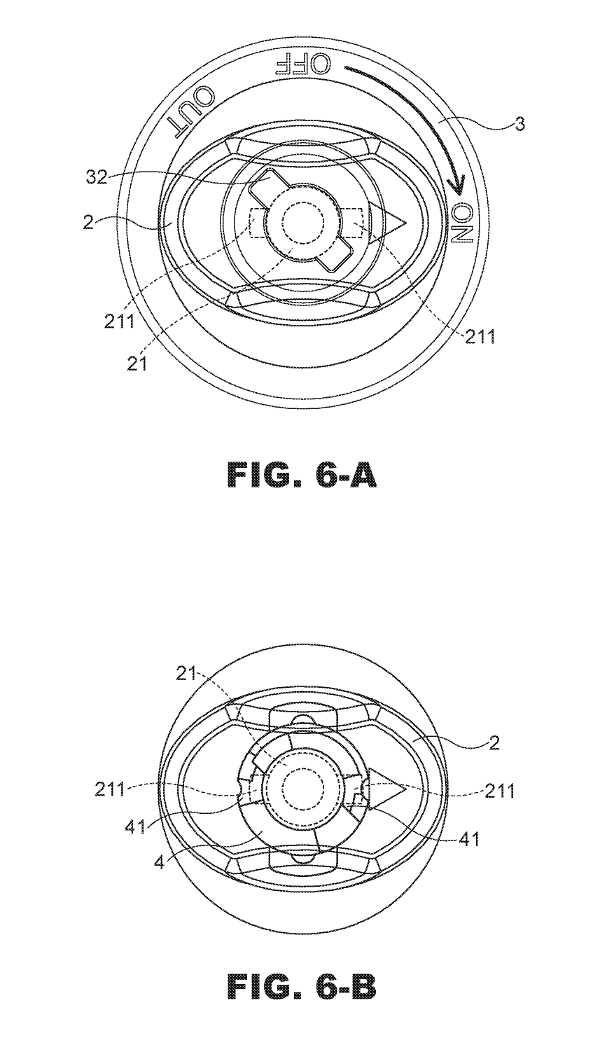

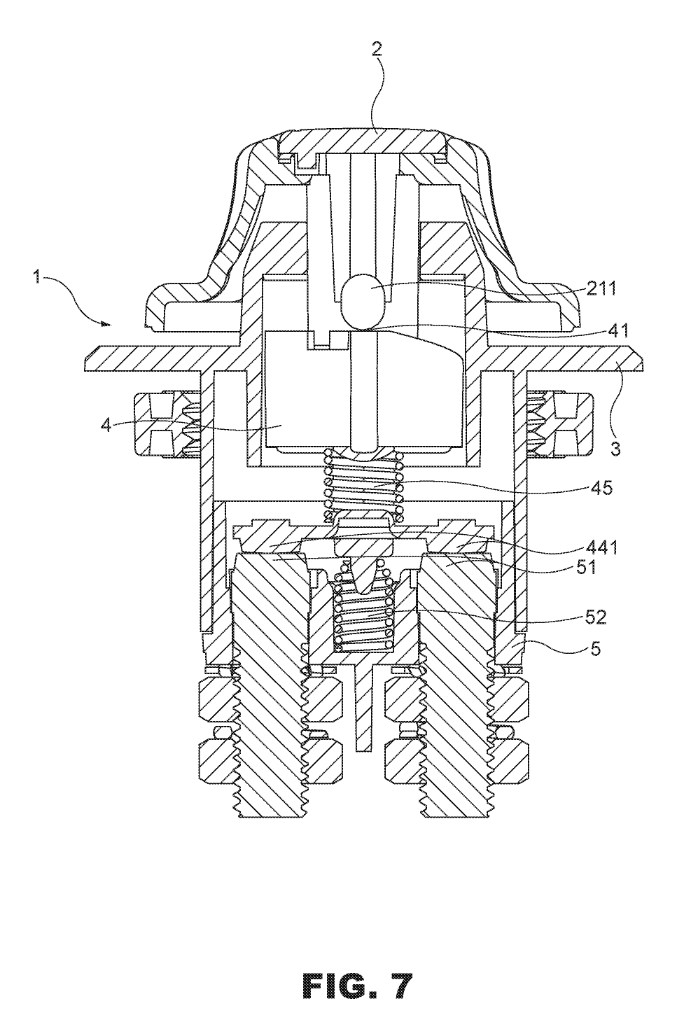

With reference to FIGS. 6-A and 6-B for setting the battery to an ON state, the knob 2 of the switch 1 is turned to an ON position of the cap 3 as shown in FIG. 7. Now, the shaft 21 and the lug 211 of the knob 2 are not configured to be corresponsive to the position of the slot 32 of the cap 3 and are disposed on the two first planes 41 of the cam 4 (and at the highest point of the cam 4), so that the first elastic member 45 and the second elastic member 52 are compressed since the cam 4 is pressed down by the lug 211 of the knob 2, and the first contact point 441 of the cam 4 and the second contact point 51 of the base 5 are contacted with each other (as shown in FIG. 5), so that the switch 1 is situated at an ON state.

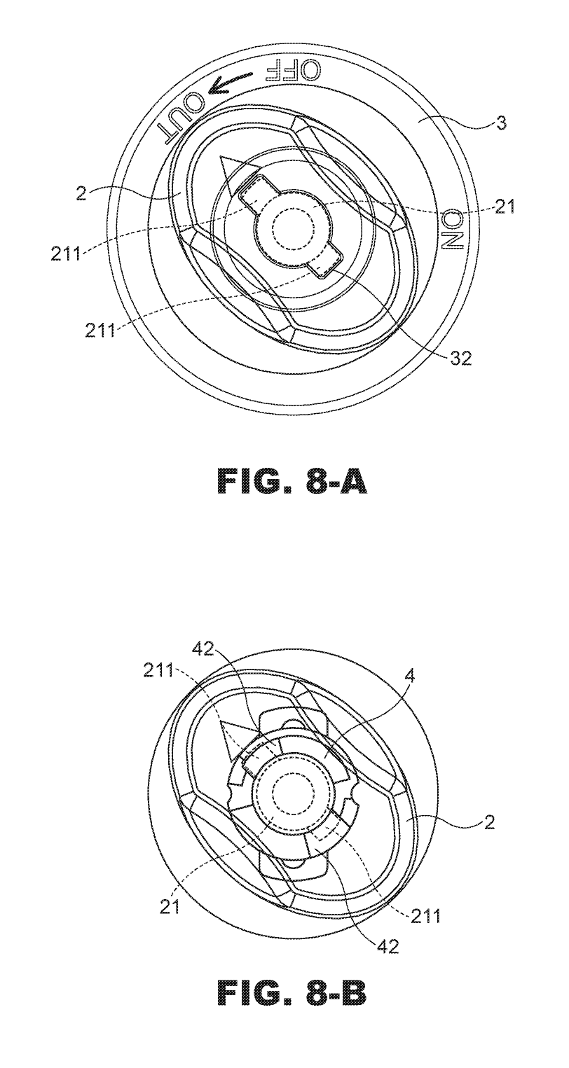

With reference to FIGS. 8-A, 8-B and 9 for using the battery with an anti-theft function, the knob 2 of the switch 1 is turned to an OUT position of the cap 3. Now, the shaft 21 and the lug 211 of the knob 2 are configured to be corresponsive to the position of the slot 32 of the cap 3 and disposed on the two second planes 42 of the cam 4, so that the shaft 21 and the lug 211 of the knob 2 can be removed from the slot 32 of the cap 3, and the switch 1 is lack of the knob 2 and cannot be operated. In addition, the switched 1 is switched to the OFF state.

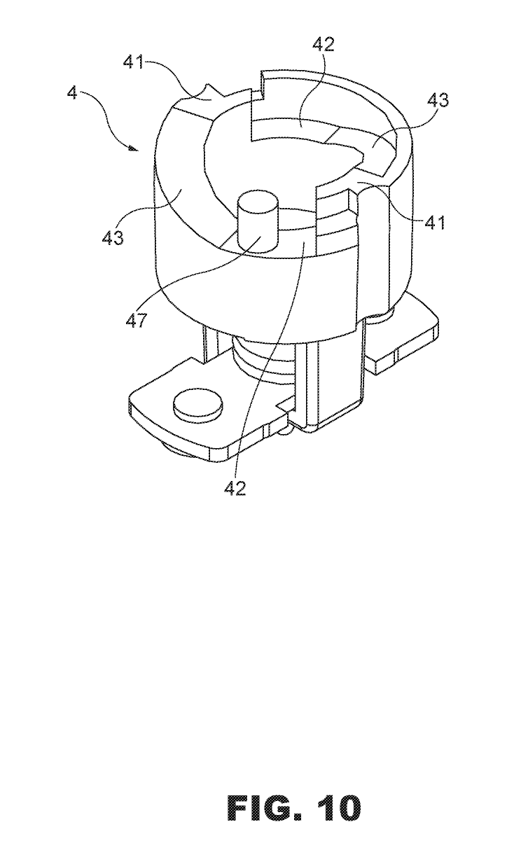

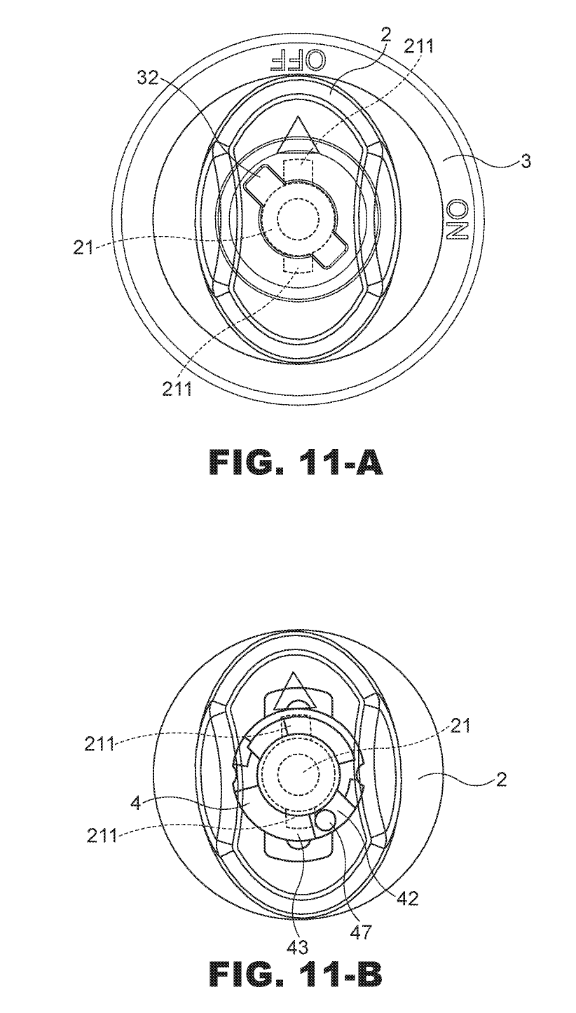

With reference to FIG. 10 for another embodiment of the present invention, when it is not necessary to use the switch 1 for the anti-theft purpose, then the cam 4 may have a cylinder 47 installed on one of the second planes 42, such that after the knob 2 is installed to the cap 3 and when it is necessary to turn the knob 2 to move the two lugs 211 to the second plane 42 (as shown in FIGS. 11-A and 11-B), the lug 211 is blocked by the cylinder 47 and cannot be moved, so that the knob 2 cannot be removed from the cap 3 in order to prevent the knob 2 from missing or lost.

By movably passing the shaft 21 of the knob 2 into the slot 32 of the cap 3 and placing the shaft 21 onto the first plane 41, the second plane 42, or the inclined plane 43 of the cam 4, the knob 2 may be turned according to a user requirement, so that the lug 211 of the knob 2 may be slid and moved to the first plane 41, the inclined plane 43, or the second plane 42 to achieve the effects of connecting or disconnecting the battery or preventing any unauthorized removal of the knob 2. When the anti-theft function is not needed, the second plane 42 of the cam 4 may have a cylinder 47 installed thereon, so that the lug 211 of the knob 2 is blocked by the cylinder 47 and cannot be configured to be corresponsive to the slot 32 of the cap 3 to achieve the effect of preventing the knob 2 from missing or being lost.

While this disclosure has been described by means of specific embodiments, numerous modifications and variations could be made thereto by those skilled in the art without departing from the scope and spirit of this disclosure set forth in the claims.

What is claimed is:

1. A switch of a battery, comprising:
a knob, having a shaft formed therein, and a lug disposed on both sides of the shaft separately;
a cap, having a containing space formed therein, and a slot formed at the exterior of the cap and being in a shape corresponsive to the shaft and the lug of the cap, for passing the knob into the slot;
a cam, installed in the containing space of the cap, and having two first planes and two second planes disposed at corresponsive positions of the external periphery of the cam and two inclined planes coupled to the first plane and the second plane, and the plane and the inclined plane being provided for sliding the lug, and the cam having a metal plate installed at the bottom of the cam, and a first elastic member being disposed between the cam and the metal plate, and the metal plate having two first contact points formed thereon; and
a base, for containing the cam, and having two second contact points formed at the interior of the base, and a second elastic member being disposed between the base and the cam, and two terminal columns being formed at the bottom of the base.

2. The switch of a battery according to claim 1, further comprising a cylinder disposed above one of the second planes.

3. The switch of a battery according to claim 1, wherein the cam has at least one arc groove formed at the external periphery of the cam, and an arc column formed in the containing space of the cap, so that the cam can be embedded with the arc column in the containing space through the arc groove.

4. The switch of a battery according to claim 1, wherein the cap has two openings formed on an outer side of the cap, a bump formed on an outer side of the base and configured to be corresponsive to the respective opening, so that the cap and the base are engaged through the opening and the bump.

5. The switch of a battery according to claim 1, wherein the first elastic member is a spring.

6. The switch of a battery according to claim 1, wherein the second elastic member is a spring.
